(19) United States
(12) Patent Application Publication
(10) Pub. No.: US 2017/0037235 A1
(43) Pub. Date: Feb. 9, 2017

(54) USE OF HIGH RUBBER IMPACT MODIFIERS IN THERMOPLASTIC FORMULATIONS

(71) Applicant: Arkema Inc., King of Prussia, PA (US)

(72) Inventors: Jason M. LYONS, King of Prussia, PA (US); Mark L. LAVACH, Allentown, PA (US)

(21) Appl. No.: 15/303,772

(22) PCT Filed: Apr. 8, 2015
(86) PCT No.: PCT/US2015/024819

§ 371 Date: Oct. 13, 2016

Related U.S. Application Data
(60) Provisional application No. 61/980,073, filed on Apr. 16, 2014.

(51) Int. Cl. C08L 27/06

(52) U.S. Cl. CPC C08L 27/06; C08L 2207/53; C08L 2205/06; C08L 2201/08; C08L 2205/03

(57) ABSTRACT

A thermoplastic composition comprises a thermoplastic resin (e.g., PVC) and less than 4.0 parts of a core-shell impact modifier per 100 parts by weight of the thermoplastic resin, wherein the core-shell impact modifier has a rubber content of at least 90%. A core-shell impact modifier composition comprises core-shell impact modifier particles having a rubber content that is greater than 92 wt % of the core-shell impact modifier particles. Articles of manufacture made from the thermoplastic compositions are also disclosed.

### FIELD OF THE INVENTION

The present invention relates to core-shell impact modifiers with high rubber content; methods for using the impact modifiers in thermoplastic formulations, particularly polyvinyl chloride (PVC) formulations; and products made by those methods.

### BACKGROUND OF THE INVENTION

Polyvinyl chloride (PVC) is widely used in such applications as films, siding, sheets, pipe, window profiles, fencing, decking and tubing. It is often the case that PVC by itself is brittle and does not possess suitable impact strength for various end uses. To overcome this shortcoming, PVC is often blended with impact modifiers so that it is less prone to failure on impact.

Known impact modifiers include core-shell impact modifiers and chlorinated polyethylene (CPE). Core-shell impact modifiers contain a relatively soft rubbery “core” (for example, polybutadiene) surrounded by a relatively hard “shell” (for example, poly(methyl methacrylate)). The weight percentage of the rubbery phase based on the total core-shell polymer particle has typically not exceeded 90 weight percent to avoid compromising the strength of the shell coverage. A common low-cost alternative to core-shell impact modifiers is chlorinated polyethylene (CPE). For example, in U.S. Pat. No. 3,006,889, chlorinated polyethylenes blended with PVC are disclosed. Historically, CPE was used at increased loading levels to attain equivalent performance to core-shell impact modifiers. However, recent advances in CPE technology made it possible to use CPE at loading levels equivalent to those of core-shell impact modifiers at lower cost.

In many cases, manufacturers would like to switch from CPE to core-shell impact modifiers for use with their PVC resins because core-shell impact modifiers offer many advantages; for example, core-shell impact modifiers can act as lubricants, and they have excellent impact efficiency, weatherability, and processability over a broad range of blending and extrusion conditions (e.g., they provide manufacturers with more flexibility to adjust various parameters during the compounding or blending process, such as fusion times). Despite the advantages of core-shell impact modifiers, CPE has been more commonly used due to its lower cost. Various methods have been suggested for improving the impact strength of CPE in PVC resins; for example, in U.S. Pat. No. 5,338,803 and European Patent Application No. 0,343,657. However, there remains a need for cost-effective compositions and methods that enable manufacturers to replace CPE with core-shell impact modifiers in thermoplastic formulations, particularly PVC formulations.

### SUMMARY OF THE INVENTION

Embodiments of the present invention relate to compositions and methods that enable manufacturers to cost-effectively replace CPE with core-shell impact modifiers in thermoplastic formulations, particularly PVC formulations. Embodiments of the invention also relate to products made by such methods.

Embodiments of the present invention relate to a thermoplastic composition comprising, consisting essentially of, or consisting of a thermoplastic resin (e.g., PVC resin) and less than 4.0 parts (e.g., between 1.0 parts and 3.0 parts, or between 1.5 parts and 2.5 parts) of a core-shell impact modifier per 100 parts by weight of the thermoplastic resin, wherein the core-shell impact modifier has a rubber content of at least 90 wt % (e.g., between 90 wt % and 96 wt %, or between 92 wt % and 95 wt %). According to preferred embodiments, a product formed from the composition has a normalized mean impact resistance that is equivalent to, or greater than, the normalized mean impact resistance of a product formed from a composition that is identical except that it includes at least 3.5 parts of CPE per 100 parts of the thermoplastic resin instead of the core-shell impact modifier. According to particular embodiments, the composition further includes at least one additional ingredient selected from the group consisting of (i) at least one stabilizer, (ii) at least one lubricant, (iii) at least one process aid, (iv) at least one mineral filler, and (v) a combination thereof.

Embodiments of the present invention also relate to a method for making a thermoplastic composition comprising, consisting essentially of, or consisting of blending a thermoplastic resin (e.g., a PVC resin) with less than 4.0 parts (e.g., between 1.0 parts and 3.0 parts, or between 1.5 parts and 2.5 parts) of a core-shell impact modifier per 100 parts of the thermoplastic resin, wherein the core-shell impact modifier has a rubber content of at least 90% (e.g., between 90 wt % and 96 wt %, or between 92 wt % and 95 wt %). According to particular embodiments, the method further includes the step(s) of blending at least one additional ingredient with the thermoplastic resin and the core-shell impact modifier, wherein the at least one ingredient is selected from the group consisting of (i) at least one stabilizer, (ii) at least one lubricant, (iii) at least one process aid, (iv) at least one mineral filler, and (v) a combination thereof.

Embodiments of the present invention also relate to articles of manufacture comprising the above-described thermoplastic compositions, for example, in the form of a pipe, flooring, foam, siding, fencing, paneling, decking, capstock, a window frame, or a door frame.

The present invention provides compositions and methods that enable manufacturers to cost-effectively replace CPE with core-shell impact modifiers in thermoplastic formulations. The applicants have discovered that core-shell impact modifiers can be included in thermoplastic formulations, particularly PVC formulations, at lower loading levels than previously considered possible, particularly when the rubber content is at least 90 wt %. The applicants' thermoplastic formulations with reduced loading levels of core-shell impact modifiers (e.g., less than 4.0 parts of core-shell impact modifier per 100 parts of a PVC resin) have been found to demonstrate equivalent or improved impact performance compared to formulations with conventional loading levels. The applicants have further discovered that the rubber content of core-shell impact modifiers can be increased to levels higher than previously known, without compromising shell coverage; for example, higher than 92 wt % rubber content. These discoveries have enabled the applicants to produce performance effective core-shell impact modifiers that also are cost-effective, and that can be used at a fraction of the loading level of CPE without compromising mechanical performance. Among other advantages, the core-shell impact modifiers also provide wider processing windows compared to CPE.

### DETAILED DESCRIPTION

One aspect of the present invention relates to a thermoplastic composition comprising, consisting essentially of, or consisting of a thermoplastic resin (preferably a PVC resin) and less than 4.0 parts of a core-shell impact modifier per 100 parts by weight of the thermoplastic resin, wherein the core-shell impact modifier has a rubber content of at least 90 wt %. According to preferred embodiments, a product formed by the composition has a normalized mean impact resistance (mean failure energy per mil) that is equivalent to, or greater than, the normalized mean impact resistance of a product formed by a composition that is identical except that it includes at least 3.5 parts of CPE per 100 parts of the thermoplastic resin instead of the core-shell impact modifier. The normalized mean impact resistance (mean failure energy per mil) may be measured, for example, by forming the thermoplastic composition into a sheet and performing a dart drop impact test using ASTM D 4226, procedure A to calculate the normalized mean failure energy (normalized mean impact resistance) of each extruded composition. Other suitable methods may alternatively be used (e.g., ASTM D 256). The composition may be formed into a sheet by extruding the composition into a sheet to a thickness of about 40 mils (e.g., by adding the composition to a Brabender conical twin screw extruder with a 6 inch flex-lip sheet die and extruding the composition with extruder settings of Zone 1, 172° C.; Zone 2, 176° C.; Zone 3, 183° C.; die 182° C.; screw speed, 35 rpm; and feeder setting of 55). Alternatively, the composition may be formed into a sheet by (1) milling at 190° C., wherein speed=25 rpm, friction (speed ratio between first and second roll)=1.20, gap=0.36 inches, for a mill time of 3 minutes; and cutting and folding the material on the mill every 30 seconds post banding to mix; (2) removing the sheet from the mill, folding the sheet into a 6×6 square and setting it into a 7×7×0.125 inch frame with aluminum sheets; (3) pressing at 195° C., 2 minutes on low pressure at 5 tons, 3 minutes on high pressure at 25 tons; (4) transferring to a cooling press; (5) cooling for 3.5 minutes on low pressure.

Core-shell impact modifiers are in the form of particles having an inner elastomer core (also referred to herein as a rubber core) and at least one outer thermoplastic shell situated on the inner elastomer core. As used herein, the “rubber content” of core-shell impact modifier particles refers to the weight percent of the rubber core in the particles based on the total weight of the particles. According to particular embodiments, the particle size of a core-shell impact modifier is generally less than 1 μm; for example, between about 50 nm and about 1,000 nm, or between about 50 nm and about 500 nm, or between about 80 nm and about 700 nm, most preferably between about 90 nm and about 350 nm. Particle size may be measured, for example, with a NiComp® Model 380 ZLS. The core-shell polymer particles are typically spherically-shaped; however, they can have any suitable shape. In preferred embodiments, the core-shell modifier particles included in the thermoplastic composition have equivalent or substantially equivalent mean particle diameters (i.e., the composition does not include more than one population of core-shell modifier particles having different mean particle diameters).

According to particular embodiments, the core-shell impact modifier has a rubber content of at least 90 wt %, or at least 90.5 wt %, or at least 91 wt %, or at least 91.5 wt %, or at least 92 wt %, or at least 92.5 wt %, or at least 93 wt %, or at least 93.5 wt %, or at least 94 wt %, or at least 94.5 wt %, or at least 95 wt %. According to alternative embodiments, the core-shell impact modifier has a rubber content between 90 wt % and 97 wt %, or between 90 wt % and 96.5 wt %, or between 90 wt % and 96 wt %, or between 90 wt % and 95.5 wt %, or between 90 wt % and 95 wt %, or between 91 wt % and 97 wt %, or between 91 wt % and 96.5 wt %, or between 91 wt % and 96 wt %, or between 91 wt % and 95.5 wt %, or between 91 wt % and 95 wt %, or between 92 wt % and 97 wt %, or between 92 wt % and 96.5 wt %, or between 92 wt % and 96 wt %, or between 92 wt % and 95.5 wt %, or between 92 wt % and 95 wt %. According to preferred embodiments, the core-shell impact modifier has a rubber content between 90 wt % and 96 wt %, or between 92 wt % and 95 wt %. It should be understood that the core-shell impact modifiers of the present invention include a rubber core and at least one outer thermoplastic shell (as described herein); therefore, they have a “rubber content” of less than 100 wt % (e.g., less than 99 wt %, or less than 98 wt %, or less than 97 wt %, or less than 96 wt %).

According to particular embodiments, the thermoplastic composition includes less than 4.0 parts of a core-shell impact modifier per 100 parts of the thermoplastic resin, or less than 3.9 parts, or less than 3.8 parts, or less than 3.7 parts, or less than 3.6 parts, or less than 3.5 parts, or less than 3.4 parts, or less than 3.3 parts, or less than 3.2 parts, or less 3.1 than parts, or less than 3.0 parts, or less than 2.9 parts, or less than 2.8 parts, or less than 2.7 parts, or less than 2.6 parts, or less 2.5 than parts of the core-shell impact modifier per 100 parts of the thermoplastic resin. For example, the thermoplastic composition may include between 1.0 parts to 3.9 parts, or between 1.0 parts to 3.8 parts, or between 1.0 parts to 3.7 parts, or between 1.0 parts to 3.6 parts, or between 1.0 parts to 3.5 parts, or between 1.0 parts to 3.4 parts, or between 1.0 parts to 3.3 parts, or between 1.0 parts to 3.2 parts, or between 1.0 parts to 3.1 parts, or between 1.0 parts to 3.0 parts, or between 1.0 parts to 3.0 parts, or between 1.0 parts to 2.9 parts, or between 1.0 parts to 2.8 parts, or between 1.0 parts to 2.7 parts, or between 1.0 parts to 2.6 parts, or between 1.5 parts to 2.5 parts, or between 1.5 parts to 3.9 parts, or between 1.5 parts to 3.8 parts, or between 1.5 parts to 3.7 parts, or between 1.5 parts to 3.6 parts, or between 1.5 parts to 3.5 parts, or between 1.5 parts to 3.4 parts, or between 1.5 parts to 3.3 parts, or between 1.5 parts to 3.2 parts, or between 1.5 parts to 3.1 parts, or between 1.5 parts to 3.0 parts, or preferably between 1.0 parts to 3.0 parts, or most preferably between 1.5 parts to 2.5 parts of the core-shell impact modifier per 100 parts of the thermoplastic resin.

In a preferred embodiment, the thermoplastic resin is PVC or an alloy thereof used in rigid PVC applications. The PVC resin preferably has a K value ranging from 40K to 100K, or a weight average molecular weight ranging from 25,000 Da to 200000 Da. Sample molecular weight equivalencies for K value, Mn and Mw of PVC are provided in the following table.

| Inherent | K value | Number | Weight |
|---|---|---|---|
| Viscosity | 1% | average | average |
| ASTM | in | molecular weight | molecular weight |
| D1234 | cyclohexanone | Mₙ (X 10⁻³) | M_{w} (X 10⁻³) |
| 0.42 | 45 | 15.0 | 30.0 |
| 0.47 | 48 | 18.0 | 36.0 |
| 0.52 | 50 | 20.0 | 40.0 |
| 0.57 | 53 | 22.5 | 45.0 |
| 0.62 | 55 | 25.0 | 50.0 |
| 0.67 | 57 | 27.5 | 55.0 |
| 0.73 | 59 | 30.5 | 61.0 |
| 0.78 | 61 | 33.0 | 67.0 |
| 0.83 | 63 | 36.0 | 72.0 |
| 0.88 | 65 | 38.5 | 78.0 |
| 0.92 | 67 | 41.0 | 82.5 |
| 0.98 | 69 | 44.0 | 89.5 |
| 1.03 | 70 | 47.0 | 95.0 |
| 1.08 | 72 | 50.0 | 101.0 |
| 1.13 | 74 | 52.5 | 107.5 |
| 1.21 | 76 | 57.0 | 117.0 |
| 1.30 | 79 | 62.5 | 128.5 |
| 1.40 | 82 | 68.5 | 141.0 |
| 1.60 | 87 | 81.0 | 168.0 |
| 1.80 | 92 | 93.5 | 195.0 |

Other thermoplastics which may be useful include, but are not limited to, alkyl (meth)acrylate polymers and copolymers, acrylonitrile/butadiene/styrene terpolymers, acrylonitrile/styrene/acrylate copolymers, polycarbonates, polyesters such as poly(butylene terephthalate) and poly(ethylene terephthalate), methacrylate/butadiene/styrene copolymers, high impact polystyrene, acrylonitrile/acrylate copolymers, acrylonitrile/methyl methacrylate copolymers, polyolefins, chlorinated poly(vinyl chloride) (CPVC), polyamides, polyetheresteramides (PEBAX), or alloys of the abovementioned polymers. The thermoplastic polymer can also be composed of a homopolymer of a vinylidene halide, such as 1,1-dichloroethylene or 1,1-difluoroethylene. Biodegradable polymers, such as polylactide or polyhydroxy butyrate, are also contemplated by the invention.

Any type of core-shell impact modifiers known in the art may be used in accordance with the present invention. By way of example, the core may be made of isoprene homopolymers or butadiene homopolymers, isoprene-butadiene copolymers, copolymers of isoprene with at most 98 wt % of a vinyl monomer and copolymers of butadiene with at most 98 wt % of a vinyl monomer. The vinyl monomer may be styrene, an alkylstyrene, acrylonitrile, an alkyl(meth)acrylate, butadiene or isoprene. The core of the core-shell copolymer may be completely or partly crosslinked. At least difunctional monomers may be added during the preparation of the core; these monomers may be chosen from poly(meth)acrylic esters of polyols, such as butylene di(meth)acrylate and trimethylolpropane trimethacrylate. Other difunctional monomers are, for example, divinylbenzene, trivinylbenzene, vinyl acrylate, vinyl methacrylate and triallyl cyanurate. The core can also be crosslinked by introducing into it, by grafting or as a comonomer during the polymerization, unsaturated functional monomers such as anhydrides of unsaturated carboxylic acids, unsaturated carboxylic acids and unsaturated epoxides. Mention may be made, by way of example, of maleic anhydride, (meth)acrylic acid and glycidyl methacrylate. The crosslinking may also be carried out by using the intrinsic reactivity of the monomers, for example the diene monomers.

By way of example, the shell(s) may be made of styrene homopolymers, alkylstyrene homopolymers or methyl methacrylate homopolymers, or copolymers comprising at least 70 wt % of one of the above monomers and at least one comonomer chosen from the other above monomers, another alkyl(meth)acrylate, vinyl acetate and acrylonitrile. The shell may be functionalized by introducing into it, by grafting or as a comonomer during the polymerization, unsaturated functional monomers such as anhydrides of unsaturated carboxylic acids, unsaturated carboxylic acids and unsaturated epoxides. Mention may be made, for example, of maleic anhydride, (meth)acrylic acid glycidyl methacrylate, hydroxyethyl methacrylate and alkyl(meth)acrylamides. By way of example, mention may be made of core-shell copolymers having a polystyrene shell and core-shell copolymers having a PMMA shell. The shell may also contain imide functional groups, either by copolymerization with a maleimide or by chemical modification of the PMMA by a primary amine. There are also core-shell copolymers having two shells, one made of polystyrene and the other, on the outside, made of PMMA.

Non-limiting examples of the types of core-shell impact modifiers that may be used in accordance with the present invention include methacrylate-butadiene-styrene copolymers (MBS), which typically have a core comprising a copolymer of butadiene and styrene and a shell comprising poly(methyl methacrylate) (PMMA); acrylonitrile-butadiene-styrene copolymers (ABS); or acrylic impact modifiers (AIM), which typically have an acrylic core (e.g., butyl acrylate or 2-ethylhexyl acrylate) and a PMMA shell.

According to another embodiment, the thermoplastic composition further comprises at least one stabilizer. Any stabilizer(s) suitable for use in thermoplastic formulations comprising core-shell impact modifiers may be included in compositions of the present invention. Exemplary stabilizers are known in the art. Non-limiting examples include mono-, di-, tri-alkyltins/organotins, calcium/zinc stabilizers, lead stabilizers, barium/cadmium with or without sulfates, carbonates, phenates, carboxylates, mercaptides, etc. The amount of stabilizer(s) included in the composition is not particularly limited. According to particular embodiments, the composition includes between 0.1 and 10.0 parts stabilizer(s), or between 0.2 and 7.5 parts stabilizer(s), or between 0.25 and 5.0 parts stabilizer(s) per 100 parts by weight of the thermoplastic resin.

According to another embodiment, the thermoplastic composition further comprises at least one lubricant. Any lubricant(s) suitable for use in thermoplastic formulations comprising core-shell impact modifiers may be included in compositions of the present invention. Exemplary lubricants are known in the art. Non-limiting examples include calcium stearate, fatty acids, fatty acid salts, esters (e.g., of polyols, fatty alcohols), ethylene bisstearamide (EBS), paraffin waxes, polyethylene waxes (e.g., polyethylene wax oxides), OPE waxes, Fisher-Tropsch waxes, etc. The amount of lubricant(s) included in the composition is not particularly limited. According to particular embodiments, the composition includes between 0.1 and 5.0 parts lubricant(s), or between 0.1 and 4.0 parts lubricant(s), or between 0.1 and 3.0 parts lubricant(s) per 100 parts by weight of the thermoplastic resin.

According to another embodiment of the present invention, the thermoplastic composition further comprises at least one process aid (i.e., at least one linear, non-core/shell process aid). It is known in the art that different types of process aids affect thermoplastic compositions, particularly PVC compositions, in different ways. For example, some process aids assist in the fusion of a thermoplastic composition (e.g., a PVC composition), while others add melt strength or provide lubrication. Process aids alone do not typically change the mechanical properties of a PVC composition, but they may increase the shear heating efficiency and thereby allow the fusion of the PVC to improve. The inclusion of a process aid often improves the impact performance of a thermoplastic composition, but the process aid is separate from the impact modifier(s) included in the composition (i.e., the process aid itself is not an impact modifier per se). Any process aid(s) suitable for use in thermoplastic formulations, particularly PVC formulations comprising core-shell impact modifiers, may be included in compositions of the present invention. Exemplary process aids are known in the art. Non-limiting examples include acrylic process aids, such as Plastistrength® 530, 550, 551, 552, 557, 559, 576, 770 and L1000 (available from Arkema, Inc.).

According to particular embodiments, the impact modifiers and process aid(s) are added to the thermoplastic composition as an intimate blend formed by the co-powderization of aqueous emulsions, suspensions or slurries of the impact modifier and process aid(s). They may be blended together, for example, by spray drying, coagulation, freeze coagulation or other known methods. Non-limiting examples of such methods are described in U.S. Pat. No. 8,378,013 and U.S. Publication No. 2011/0305862, which are incorporated by reference herein. According to one embodiment, a PVC composition of the present invention includes an impact modifier and at least one process aid co-spray dried together.

The amount of process aid(s) included in the composition is not particularly limited. According to particular embodiments, the composition includes between 0.1 and 10.0 parts process aid(s), or between 0.1 and 7.5 parts process aid(s), or between 0.1 and 5.0 parts process aid(s), or between 0.1 and 2.5 parts process aid(s) per 100 parts by weight of the thermoplastic resin.

According to another embodiment of the present invention, the thermoplastic composition further comprises at least one mineral filler, such as calcium carbonate (CaCO₃). Any mineral filler(s) suitable for use in thermoplastic (e.g., PVC) formulations comprising core-shell impact modifiers may be included in compositions of the present invention. Exemplary mineral fillers are known in the art. Non-limiting examples include ground natural calcium carbonate (GCC), precipitated calcium carbonate (PCC), nanosized PCC (NPCC), silica (fumed or precipitated), clay, Montmorillonite (nano-clay), zeolite, perlite, etc. The amount of mineral filler(s) included in the composition is not particularly limited. According to particular embodiments, the composition includes between 0.1 and 40.0 parts mineral filler(s), or between 0.1 and 35.0 parts mineral filler(s), or between 0.1 and 30.0 parts mineral filler(s), or between 0.1 and 25.0 parts mineral filler(s), or between 0.1 and 20.0 parts mineral filler(s), or between 0.1 and 15.0 parts mineral filler(s), or between 0.1 and 10.0 parts mineral filler(s), or between 0.1 and 5.0 parts mineral filler(s), or between 0.1 and 2.5 parts mineral filler(s) per 100 parts of the thermoplastic resin.

According to particular embodiments, the impact modifiers and mineral filler(s) are added to the thermoplastic composition as an intimate blend formed by the co-powderization of aqueous emulsions, suspensions or slurries of the impact modifier and mineral filler(s). The intimate blend may further include process aid(s) (i.e., the intimate blend may include impact modifier, mineral filler(s) and process aid(s)). The components may be blended together, for example, by spray drying, coagulation, freeze coagulation or other known methods. As noted above, non-limiting examples of such methods are described in U.S. Pat. No. 8,378,013 and U.S. Publication No. 2011/0305862. According to one embodiment, a PVC composition of the present invention includes an impact modifier and at least one mineral filler co-spray dried together. According to another embodiment, a PVC composition of the present invention includes an impact modifier, at least one process aid, and at least one mineral filler co-spray dried together.

According to additional embodiments, a thermoplastic composition comprises, consists essentially of, or consists of a thermoplastic (e.g., PVC) resin, less than 4.0 parts of a core-shell impact modifier per 100 parts by weight of the thermoplastic resin (wherein the core-shell impact modifier has a rubber content of at least 90 wt %), at least one low Tg process aid (e.g., Plastistrength® 576), and at least one mineral filler. A low Tg process aid may promote faster fusion, which enables the content of the mineral filler (e.g., calcium carbonate) in the PVC composition to be increased. As used herein, a low Tg process aid is a process aid that has a Tg less than 90° C. as measured by DSC through ASTM D3418 (Transition Temperatures of Polymer by Differential Scanning Calorimetry).

Other optional additives, such as heat stabilizers, internal and external lubricants, melt strength additives, other fillers, plasticizers, flow aids, blowing agents, and/or pigments (e.g., titanium dioxide) may also be included in thermoplastic compositions of the present invention. The amount of additive(s) included in the composition is not particularly limited. According to particular embodiments, the composition includes between 0.1 and 40.0 parts additive(s), or between 0.1 and 30.0 parts additive(s), or between 0.1 and 20.0 parts additive(s), or between 0.1 and 15.0 parts additive(s), or between 0.1 and 10.0 parts additive(s), or between 0.1 and 5.0 parts additive(s), or between 0.1 and 2.5 parts additive(s), or between 0.1 and 1.0 parts additive(s) per 100 parts of the thermoplastic resin.

According to particular embodiments, the thermoplastic composition comprises, consists essentially of, or consists of a thermoplastic resin (preferably PVC), less than 4.0 parts (e.g., between 1.0 and 3.0 parts, or between 1.5 and 2.5 parts) of a core-shell impact modifier per 100 parts of the thermoplastic resin, optionally at least one stabilizer, optionally at least one lubricant, optionally at least one process aid, optionally at least one mineral filler, and optionally at least one additional type of additive, wherein the core-shell impact modifier has a rubber content of at least 90%. According to a preferred embodiment, the thermoplastic composition comprises, consists essentially of, or consists of a thermoplastic resin (preferably PVC), less than 4.0 parts of a core-shell impact modifier per 100 parts of the PVC resin (with a rubber content of at least 90%), at least one process aid, and at least one mineral filler (e.g., calcium carbonate). According to an alternative embodiment, the thermoplastic composition comprises, consists essentially of, or consists of a thermoplastic resin (preferably PVC), less than 4.0 parts of a core-shell impact modifier per 100 parts of the PVC resin (with a rubber content of at least 90%), and at least one additional ingredient selected from the group consisting of (i) at least one stabilizer, (ii) at least one lubricant, (iii) at least one process aid, (iv) at least one mineral filler, and (v) a combination thereof,

Additional embodiments of the present invention provide articles of manufacture formed from a thermoplastic composition of the present invention (e.g., by injection molding, extrusion, calendaring, blow molding, foaming and thermoforming, etc.). Non-limiting examples of articles of manufacture include pipe, foam, siding, fencing, paneling, decking, capstock, window profiles, door profiles, etc.

Additional aspects of the present invention relate to methods for making the thermoplastic compositions and articles of manufacture described herein. The thermoplastic composition may be formulated by any means known in the art, generally as a dry blend of components that are blended until a homogeneous compound is obtained; and formed into articles of manufacture by conventional melt processing techniques (e.g., injection molding, extrusion, calendaring, blow molding, foaming and thermoforming, etc.). According to one embodiment, a method for making a thermoplastic composition comprises, consists essentially of, or consists of blending a thermoplastic resin (preferably a PVC resin) with less than 4.0 parts (e.g., between 1.0 and 3.0 parts, or between 1.5 and 2.5 parts) of a core-shell impact modifier per 100 parts of the PVC resin, wherein the core-shell impact modifier has a rubber content of at least 90% (e.g., between 90 wt % and 96 wt %, or between 92 wt % and 95 wt %). The method may further include the step(s) of blending at least one additional ingredient with the thermoplastic resin and the core-shell impact modifier, wherein the at least one ingredient is selected from the group consisting of (i) at least one stabilizer, (ii) at least one lubricant, (iii) at least one process aid, (iv) at least one mineral filler, and (v) a combination thereof. The method may further include the step of extruding the thermoplastic composition to form an article (e.g., a pipe, flooring, foam, siding, fencing, paneling, decking, capstock, a window frame, a door frame, etc.).

As the rubber core weight fraction of a core-shell impact modifier increases, there tends to be a corresponding decrease in the weight fraction, thickness, and hardness of the outer polymer shell. If the shell becomes too thin, it will not sufficiently cover the rubber core. Improper shell coverage can lead to problems, including reduced impact strength in polymer blends. Another aspect of the present invention relates to a core-shell impact modifier composition comprising, consisting essentially of, or consisting of core-shell impact modifier particles having a rubber content that is greater than 92 wt % of the core-shell impact modifier particles in the composition, or greater than 93 wt %, or greater than 94 wt %. According to other embodiments, the core-shell impact modifier particles have a rubber content between 92.5 wt % and 97 wt % of the core-shell impact modifier particles, or between 93 wt % and 96 wt %, or between 94 wt % and 96 wt %, or about 95 wt %. As discussed herein, any type of core-shell impact modifiers known in the art may be used in accordance with the present invention; for example, methacrylate-butadiene-styrene copolymers (MBS), acrylonitrile-butadiene-styrene copolymers (ABS), or acrylic impact modifiers (AIM).

According to preferred embodiments, the core-shell modifier particles have equivalent or substantially equivalent mean particle diameters (i.e., the composition does not include more than one population of core-shell modifier particles having different mean particle diameters). This is contrary to the core-shell impact modifiers described in U.S. Pat. No. 6,639,012, which are provided in two separate populations, wherein the mean particle diameter of the first population of particles is at least 50 percent larger than the mean particle diameter of the second population of particles. In accordance with the present invention, the core-shell impact modifier particles are preferably manufactured by a semi-continuous process (instead of a batch process, as described in U.S. Pat. No. 6,639,012) to produce a single population of particles, instead of two populations of particles having different mean particle diameters.

According to another embodiment of the present invention, the core-shell impact modifier composition further comprises at least one process aid. As discussed herein, any process aid(s) suitable for use in thermoplastic formulations comprising core-shell impact modifiers may be included in compositions of the present invention. Exemplary process aids are known in the art. Non-limiting examples include acrylic process aids, such as Plastistrength® 530, 550, 551, 552, 557, 559, 576, 770 and L1000 (available from Arkema, Inc.). According to a particular embodiment, a core-shell impact modifier composition comprises, consists essentially of, or consists of core-shell impact modifier particles having a rubber content that is greater than 92 wt % of the core-shell impact modifier particles in the composition (e.g., greater than 93 wt %, greater than 94 wt %, between 92.5 wt % and 97 wt %, between 93 wt % and 96 wt %, between 94 wt % and 96 wt %, or about 95 wt %) and at least one process aid. As described herein, the process aid(s) may be provided in an intimate blend with the core-shell impact modifier (e.g., by co-spray drying the core-shell impact modifier and process aid(s)).

According to another embodiment of the present invention, the core-shell impact modifier composition further comprises at least one mineral filler, such as calcium carbonate (CaCO₃). As discussed herein, any mineral filler(s) suitable for use in PVC formulations comprising core-shell impact modifiers may be included in compositions of the present invention. As described herein, the mineral filler(s) may be provided in an intimate blend with the core-shell impact modifier (e.g., by co-spray drying the core-shell impact modifier and mineral filler(s)). Exemplary mineral fillers are known in the art. According to a particular embodiment, a core-shell impact modifier composition comprises, consists essentially of, or consists of core-shell impact modifier particles having a rubber content that is greater than 92 wt % of the core-shell impact modifier particles in the composition (e.g., greater than 93 wt %, greater than 94 wt %, between 92.5 wt % and 97 wt %, between 93 wt % and 96 wt %, between 94 wt % and 96 wt %, or about 95 wt %), at least one mineral filler, and optionally at least one process aid.

Other optional additives, such as heat stabilizers, internal and external lubricants, melt strength additives, other fillers, flow aids, and/or pigments may also be included in core-shell impact modifier compositions of the present invention. According to one embodiment, a core-shell impact modifier composition comprises, consists essentially of, or consists of core-shell impact modifier particles having a rubber content that is greater than 92 wt % of the core-shell impact modifier particles in the composition (e.g., greater than 93 wt %, greater than 94 wt %, between 92.5 wt % and 97 wt %, between 93 wt % and 96 wt %, between 94 wt % and 96 wt %, or about 95 wt %), optionally at least one mineral filler, optionally at least one process aid, and at least one optional additive. The amount of each component included in the core-shell impact modifier compositions is not particularly limited. According to particular embodiments, the composition includes 50 wt % to 99 wt % core-shell impact modifier particles, 1 wt % to 50 wt % of the at least one process aid, 0 wt % to 50 wt % of the at least one mineral filler, 0 wt % to 20 wt % of the at least one additive, based on the total weight of the composition.

Another embodiment of the present invention provides a resin composition comprising a thermoplastic resin and a core-shell impact modifier composition as described herein (e.g., a core-shell impact modifier composition that comprises, consists essentially of, or consists of core-shell impact modifier particles having a rubber content that is greater than 92 wt % of the core-shell impact modifier particles in the composition, optionally at least one mineral filler, optionally at least one process aid, and optionally at least one additive). In a preferred embodiment, the at least one thermoplastic resin is PVC or an alloy thereof used in rigid PVC applications.

The embodiments described herein are intended to be exemplary of the invention and not limitations thereof. One skilled in the art will appreciate that modifications to the embodiments and examples of the present disclosure may be made without departing from the scope of the present disclosure.

The embodiments of the invention are described above using the term “comprising” and variations thereof. However, it is the intent of the inventors that the term “comprising” may be substituted in any of the embodiments described herein with “consisting of” and “consisting essentially of” without departing from the scope of the invention. Unless specified otherwise, all values provided herein include up to and including the starting points and end points given.

The following examples further illustrate embodiments of the invention and are to be construed as illustrative and not in limitation thereof.

### Examples

As used herein, a high molecular weight process aid has a weight average molecular weight of over 5,000,000 Da; a medium molecular weight process aid has a molecular weight between about 1,000,000 Da and about 5,000,000 Da; and a low molecular weight process aid has a molecular weight of less than 1,000,000 Da.

An embodiment of a PVC formulation of the present invention comprises, consists essentially of, or consists of the following components:

PVC Resins (100 parts)

Stabilizer(s) (0.25-5.0 parts)

Lubricant Package of

1. Calcium Stearate (0.0-3.0 parts)

2. Parrafin wax (0.0-3.0 parts)

3. Oxidized polyethylene wax (0.0-3.0 parts)

Core-shell impact modifier(s) (0.25-3.5 parts)

Process aid(s) (0.0-5.0 parts)

Lubricating process aid(s) (0.0-5.0 parts)

Calcium Carbonate (0.0-35.0 parts)

Titanium Dioxide (0.0-15 parts)

An embodiment of a composition of the present invention that may be used in the manufacture of siding substrate or fencing substrate comprises, consists essentially of, or consists of the following components (the core-shell impact modifier, process aid(s), and calcium carbonate may optionally be included as an intimate blend that has been co-spray dried together):

| Components | phr | Range |
|---|---|---|
| PVC-5385, K65 (available from Axiall/Georgia Gulf) | 100.0 | |
| Thermolite ® 140 (stabilizer, available from PMC) | 1.0 | 0.5-1.5 |
| Calcium stearate | 1.2 | 0.5-1.5 |
| Rheolub ® 165 (lubricant, available from Honeywell) | 1.1 | 0.5-1.5 |
| AC ® 629A (lubricant, available from Honeywell) | 0.1 | 0.0-0.5 |
| Durastrength ® 350 (acrylic core-shell impact modifier | 3.0 | 1.5-3.5 |
| with 90 wt % rubber content, available from Arkema, | | |
| Inc.) | | |
| Plastistrength ® 530 (high molecular weight process | 0.5 | 0.1-1.5 |
| aid, available from Arkema, Inc.) | | |
| P770 (low molecular weight process aid, available | 0.4 | 0.0-1.5 |
| from Arkema, Inc.) | | |
| CaCO₃ (UFT, available from Omya) | 15.0 | 10-25 |
| TiO₂ (TiONA ® RCL-4) | 3.0 | 1-5 |
| Total | 125.3 | |

An embodiment of a composition of the present invention that may be used in the manufacture of a window profile or siding capstock comprises, consists essentially of, or consists of the following components (the core-shell impact modifier, process aid(s), and calcium carbonate may optionally be included as an intimate blend that has been co-spray dried together):

| Components | phr | Range |
|---|---|---|
| PVC-5385, K65 (available from Axiall/Georgia Gulf) | 100.0 | |
| Thermolite ® 179 for window profile (stabilizer, | 1.0 | 0.7-1.5 |
| available from PMC); or Thermolite ® 161 for siding | | |
| capstock (stabilizer, available from PMC) | | |
| Calcium stearate | 1.2 | 0.9-1.5 |
| Rheolub ® 165 (lubricant, available from Honeywell) | 1.0 | 0.5-1.5 |
| AC ® 629A (lubricant, available from Honeywell) | 0.1 | 0.0-0.5 |
| Durastrength ® 350 (acrylic core-shell impact modifier | 3.5 | 1.5-3.5 |
| with 90 wt % rubber content, available from Arkema, | | |
| Inc.) | | |
| Plastistrength ® 530 (high molecular weight process | 0.6 | 0.4-0.8 |
| aid, available from Arkema, Inc.) | | |
| P770 (low molecular weight process aid, available | 0.4 | 0.0-0.6 |
| from Arkema, Inc.) | | |
| CaCO₃ (UFT, available from Omya) | 5.0 | 3-8 |
| TiO₂ (TiONA ® RCL-4) | 10.0 | 9-12 |
| Total | 122.8 | |

An embodiment of a composition of the present invention that may be used in the manufacture of siding substrate comprises, consists essentially of, or consists of the following components (the core-shell impact modifier, process aid(s), and calcium carbonate may optionally be included as an intimate blend that has been co-spray dried together):

| Components | phr | Range |
|---|---|---|
| PVC-5385, K65 (available from Axiall/Georgia Gulf) | 100.0 | |
| Thermolite ® 140 (stabilizer, available from PMC) | 1.0 | 0.7-1.5 |
| Calcium stearate | 1.2 | 0.9-1.5 |
| Rheolub ® 165 (lubricant, available from Honeywell) | 1.0 | 0.5-1.5 |
| AC ® 629A (lubricant, available from Honeywell) | 0.1 | 0.0-0.5 |
| Durastrength ® 350 (acrylic core-shell impact | 2.0 | 1.5-3.5 |
| modifier with 90 wt % rubber content, available from | | |
| Arkema, Inc.) | | |
| Plastistrength ® 576 (low Tg, high molecular weight | 0.2 | 0.0-3.0 |
| process aid, available from Arkema, Inc.) | | |
| CaCO₃ (UFT, available from Omya) | 12.0 | 1-30 |
| TiO₂ (TiONA ® RCL-4) | 0.5 | 0.1-5 |
| Total | 118.0 | |

Tables 1-3 below describe the colors and gloss of extruded sheets (Table 1), impact performance (Table 2), and processing times (Table 3) for PVC formulations that are identical except for the following impact modifiers, or combination of impact modifiers, as indicated in the tables:

D3000=an intimate blend of core-shell impact modifier, process aid, and calcium carbonate co-spray dried together (available from Arkema, Inc.);

PD1133=an intimate blend of core-shell impact modifier, process aid, and calcium carbonate co-spray dried together (available from Arkema, Inc.);

CPE=Chlorinated polyethylene;

P530=Plastistrength® 530 high molecular weight process aid (Arkema, Inc.);

D350=Durastrength® 350 (Arkema, Inc.) acrylic impact modifier with 90 wt % rubber content; and

P576=Plastistrength® 576 low Tg, high molecular weight process aid (Arkema, Inc.).

In Table 1 below, the following abbreviations are used:

IM (Impact Modifier) Level=number of parts of Impact Modifier per 100 parts PVC resin;

PA (Process Aid) Level=number of parts of Process Aid per 100 parts PVC resin;

L=Hunter L;

A=Hunter A;

B=Hunter B;

Yl=yellow index; and

20°, 60°, and 85°=gloss degree.

TABLE 1
(Brabender conical twin screw with 40 mil 6 inch sheet die)

| Sample | | IM Level (phr) | PA Level (phr) | L | A | B | Yl |
|---|---|---|---|---|---|---|---|
| 1 | D3000 | 3.0 | | 89.46 | −0.73 | 4.50 | 8.41 |
| 2 | | 3.5 | | 89.52 | −0.74 | 4.60 | 8.60 |
| 3 | | 4.0 | | 89.51 | −0.76 | 4.65 | 8.69 |
| 4 | PD1133 | 3.0 | | 89.56 | −0.62 | 4.41 | 8.31 |
| 5 | | 3.5 | | 89.46 | −0.78 | 4.61 | 8.60 |
| 6 | | 4.0 | | 89.49 | −0.77 | 4.53 | 8.43 |
| 7 | CPE | 3.0 | | 89.05 | −0.84 | 5.14 | 9.65 |
| 8 | | 3.5 | | 89.19 | −0.83 | 5.22 | 9.80 |
| 9 | | 4.0 | | 89.10 | −0.75 | 5.03 | 9.49 |
| 10 | CPE + P530 | 3.0 | 0.5 | 89.25 | −0.81 | 5.15 | 9.67 |
| 11 | | 3.5 | 0.5 | 89.22 | −0.82 | 5.24 | 9.85 |
| 12 | | 4.0 | 0.5 | 89.13 | −0.84 | 5.27 | 9.90 |
| 13 | D350 | 2.0 | | 89.48 | −0.73 | 4.52 | 8.45 |
| 14 | D350 + P576 | 2.0 | 0.4 | 89.61 | −0.78 | 4.64 | 8.64 |
| 15 | D350 + P576 | 3.0 | 0.2 | 89.62 | −0.81 | 4.67 | 8.67 |
| 16 | D350 | 4.0 | | 89.63 | −0.85 | 4.71 | 8.73 |
| 17 | D350 + P576 | 4.0 | 0.4 | 89.68 | −0.84 | 4.72 | 8.74 |
| 18 | D350 + P530 | 2.0 | 0.4 | 89.56 | −0.77 | 4.58 | 8.53 |
| 19 | D350 + P530 | 3.0 | 0.2 | 89.62 | −0.78 | 4.55 | 8.45 |
| 20 | D350 + P530 | 4.0 | 0.4 | 89.63 | −0.78 | 4.50 | 8.36 |

| Sample | | 20° | 60° | 85° |
|---|---|---|---|---|
| 1 | D3000 | 3.5 | 31.0 | 82.3 |
| 2 | | 3.6 | 31.2 | 82.8 |
| 3 | | 3.9 | 32.6 | 83.6 |
| 4 | PD1133 | 3.9 | 32.6 | 83.7 |
| 5 | | 4.8 | 36.7 | 85.7 |
| 6 | | 4.6 | 36.5 | 85.4 |
| 7 | CPE | 5.3 | 38.6 | 85.5 |
| 8 | | 5.6 | 39.9 | 85.6 |
| 9 | | 6.8 | 43.9 | 85.8 |
| 10 | CPE + P530 | 7.3 | 46.1 | 86.4 |
| 11 | | 7.6 | 46.7 | 86.7 |
| 12 | | 8.5 | 49.3 | 88.1 |
| 13 | D350 | 7.4 | 46.0 | 87.6 |
| 14 | D350 + P576 | 7.0 | 45.0 | 87.0 |
| 15 | D350 + P576 | 6.5 | 43.6 | 86.7 |
| 16 | D350 | 5.7 | 40.7 | 85.4 |
| 17 | D350 + P576 | 6.5 | 43.3 | 86.4 |
| 18 | D350 + P530 | 6.5 | 43.1 | 86.4 |
| 19 | D350 + P530 | 6.3 | 42.6 | 86.3 |
| 20 | D350 + P530 | 7.0 | 46.3 | 86.2 |

A dart drop impact test using ASTM D 4226, procedure A was performed to determine the normalized mean failure energy (normalized mean impact resistance) of each extruded composition shown below.

In Table 2 below, the following abbreviations are used:

IM (Impact Modifier) Level=number of parts of Impact Modifier per 100 parts PVC resin;

PA (Process Aid) Level=number of parts of Process Aid per 100 parts PVC resin;

MFE=Mean Failure Energy;

Thickness=thickness of the film (in mils);

MFE/mil=Mean Failure Energy per mil.

TABLE 2
(Brabender conical twin screw with 40 mil 6 inch sheet
die/Gardner Drop Dart 8 lb weight, ½ inch tup)

| Sample | | IM Level (phr) | PA Level (phr) | MFE | s.d. | Thickness | MFE/mil | s.d. |
|---|---|---|---|---|---|---|---|---|
| 1 | D3000 | 3.0 | | 88.80 | 8.67 | 40.0 | 2.22 | 0.22 |
| 2 | | 3.5 | | 86.67 | 11.90 | 39.0 | 2.22 | 0.31 |
| 3 | | 4.0 | | 89.33 | 11.90 | 39.0 | 2.29 | 0.31 |
| 4 | PD1133 | 3.0 | | 92.00 | 16.58 | 41.0 | 2.24 | 0.40 |
| 5 | | 3.5 | | 94.67 | 6.14 | 39.0 | 2.43 | 0.16 |
| 6 | | 4.0 | | 97.33 | 9.02 | 40.0 | 2.43 | 0.23 |
| 7 | CPE | 3.0 | | 112.44 | 3.58 | 43.0 | 2.61 | 0.08 |
| 8 | | 3.5 | | 106.22 | 2.62 | 42.0 | 2.53 | 0.06 |
| 9 | | 4.0 | | 115.20 | 4.13 | 42.0 | 2.74 | 0.10 |
| 10 | CPE + P530 | 3.0 | 0.5 | 110.40 | 5.69 | 41.0 | 2.69 | 0.14 |
| 11 | | 3.5 | 0.5 | 113.60 | 3.10 | 41.0 | 2.77 | 0.08 |
| 12 | | 4.0 | 0.5 | 113.60 | 5.69 | 42.0 | 2.70 | 0.14 |
| 13 | D350 | 2.0 | | 108.00 | 2.97 | 41.0 | 2.63 | 0.07 |
| 14 | D350 + P576 | 2.0 | 0.4 | 105.33 | 6.14 | 40.0 | 2.63 | 0.15 |
| 15 | D350 + P576 | 3.0 | 0.2 | 110.40 | 3.10 | 40.0 | 2.76 | 0.08 |
| 16 | D350 | 4.0 | | 112.44 | 3.58 | 41.0 | 2.74 | 0.09 |
| 17 | D350 + P576 | 4.0 | 0.4 | 112.44 | 3.58 | 41.0 | 2.74 | 0.09 |
| 18 | D350 + P530 | 2.0 | 0.4 | 114.40 | 5.04 | 41.0 | 2.79 | 0.12 |
| 19 | D350 + P530 | 3.0 | 0.2 | 111.20 | 3.49 | 41.0 | 2.71 | 0.09 |
| 20 | D350 + P530 | 4.0 | 0.4 | 115.20 | 4.13 | 41.0 | 2.81 | 0.10 |

The data in Table 2 demonstrate that PVC formulations that contain less than 4 parts core-shell impact modifier per 100 parts PVC resin are capable of providing higher mean failure energy (MFE) values per mil compared to PVC formulations that contain 4.0 parts CPE per 100 parts PVC resin. For example, Sample 15 (3.0 parts core-shell impact modifier), Sample 18 (2.0 parts core-shell impact modifier), and Sample 19 (3.0 parts core-shell impact modifier) provided MFE/mil values of 2.76, 2.79 and 2.71, respectively, compared to Sample 12 (4.0 parts CPE), which provided an MFE/mil value of 2.70.

Table 3 below shows additive combinations at various loading levels run on a Brabender torque rheometer following ASTM D2538. In this analysis, Fusion Time was measured as the delta between the compaction peak and the fusion peak, Fusion Torque was measured as the height of the fusion peak, and Equilibrium Torque (EQ Torque) was measured as the torque after fusion when the slope of the torque/temperature graph is zero. Bulk Density was measured using ASTM D1895.

TABLE 3

| | | | | | | |
|---|---|---|---|---|---|---|
| | IM | PA | Bulk | Fusion | Fusion | EQ |
| | Level | Level | Density | Time | Torque | Torque |
| Sample | (phr) | (phr) | (g/100 cc) | (min) | (m-g) | (m-g) |

Brabender Fusion 170 C.

| | | | | | | | |
|---|---|---|---|---|---|---|---|
| 3 | D3000 | 4.0 | | 68.2 | 1.03 | 3436 | 2830 |
| 6 | PD1133 | 4.0 | | | | | |
| 9 | CPE | 4.0 | | 68.0 | 0.63 | 3628 | 2763 |
| 12 | CPE + P530 | 4.0 | 0.5 | 68.0 | 0.67 | 3745 | 2682 |
| 13 | D350 | 2.0 | | 68.2 | 1.20 | 3395 | 2810 |
| 14 | D350 + P576 | 2.0 | 0.4 | 68.2 | 1.13 | 3613 | 2887 |
| 15 | D350 + P576 | 3.0 | 0.2 | 68.0 | 1.07 | 3605 | 2879 |
| 16 | D350 | 4.0 | | 68.0 | 0.87 | 3621 | 2925 |
| 17 | D350 + P576 | 4.0 | 0.4 | 68.0 | 0.87 | 3800 | 2768 |
| 18 | D350 + P530 | 2.0 | 0.4 | 68.0 | 1.13 | 3499 | 2773 |
| 19 | D350 + P530 | 3.0 | 0.2 | 68.1 | 0.90 | 3556 | 2785 |
| 20 | D350 + P530 | 4.0 | 0.4 | 68.0 | 0.87 | 3734 | 2712 |

Brabender Fusion 190 C.

| | | | | | | | |
|---|---|---|---|---|---|---|---|
| 3 | D3000 | 4.0 | | 68.2 | 0.57 | 3203 | 2216 |
| 6 | PD1133 | 4.0 | | | | | |
| 9 | CPE | 4.0 | | 68.0 | 0.33 | 3648 | 2294 |
| 12 | CPE + P530 | 4.0 | 0.5 | 68.0 | 0.34 | 3639 | 2284 |
| 13 | D350 | 2.0 | | 68.2 | 0.57 | 3160 | 2176 |
| 14 | D350 + P576 | 2.0 | 0.4 | 68.2 | 0.57 | 3207 | 2229 |
| 15 | D350 + P576 | 3.0 | 0.2 | 68.0 | 0.50 | 3356 | 2204 |
| 16 | D350 | 4.0 | | 68.0 | 0.53 | 3332 | 2175 |
| 17 | D350 + P576 | 4.0 | 0.4 | 68.0 | 0.50 | 3477 | 2209 |
| 18 | D350 + P530 | 2.0 | 0.4 | 68.0 | 0.53 | 3182 | 2169 |
| 19 | D350 + P530 | 3.0 | 0.2 | 68.1 | 0.53 | 3264 | 2172 |
| 20 | D350 + P530 | 4.0 | 0.4 | 68.0 | 0.47 | 3411 | 2182 |

1. A thermoplastic composition comprising:
a thermoplastic resin; and less than 4.0 parts of a core-shell impact modifier per 100 parts of the thermoplastic resin, wherein the core-shell impact modifier has a rubber content of at least 90%.

2. The thermoplastic composition of claim 1, wherein the thermoplastic resin is PVC.

3. The thermoplastic composition of claim 1, wherein the core-shell impact modifier is selected from the group consisting of methacrylate-butadiene-styrene copolymers (MBS), acrylonitrile-butadiene-styrene copolymers (ABS), acrylic core/shell polymers (AIM), and a combination thereof.

4. The thermoplastic composition of claim 1 comprising between 1.0 parts to 3.0 parts of the core-shell impact modifier per 100 parts of the thermoplastic resin.

5. The thermoplastic composition of claim 1 comprising between 1.5 parts to 2.5 parts of the core-shell impact modifier per 100 parts of the thermoplastic resin.

6. The thermoplastic composition of claim 1, wherein the core-shell impact modifier has a rubber content between 90 wt % and 96 wt %.

7. The thermoplastic composition of claim 1, wherein the core-shell impact modifier has a rubber content between 92 wt % and 95 wt %.

8. The thermoplastic composition of claim 1, wherein a product formed from the composition has a normalized mean impact resistance that is equivalent to, or greater than, the normalized mean impact resistance of a product formed from a composition that is identical except that it includes at least 3.5 parts of CPE per 100 parts of the thermoplastic resin instead of the core-shell impact modifier.

9. The thermoplastic composition of claim 1, further comprising at least one additional ingredient selected from the group consisting of (i) at least one stabilizer, (ii) at least one lubricant, (iii) at least one process aid, (iv) at least one mineral filler, and (v) a combination thereof.

10. An article comprising the thermoplastic composition of claim 1 in the form of a pipe, flooring, foam, siding, fencing, paneling, decking, capstock, a window frame, or a door frame.

11. A method for making a thermoplastic composition comprising:
blending a thermoplastic resin with less than 4.0 parts of a core-shell impact modifier per 100 parts of the thermoplastic resin, wherein the core-shell impact modifier has a rubber content of at least 90%.

12. The method of claim 11 further comprising blending at least one additional ingredient with the thermoplastic resin and the core-shell impact modifier, wherein the at least one ingredient is selected from the group consisting of (i) at least one stabilizer, (ii) at least one lubricant, (iii) at least one process aid, (iv) at least one mineral filler, and (v) a combination thereof.

13. The method of claim 11 further comprising extruding the thermoplastic composition to form an article.

14. An article manufactured according to the method of claim 13, wherein the article is in the form of a pipe, flooring, foam, siding, fencing, paneling, decking, capstock, a window frame, or a door frame.

15. The method of claim 11, wherein the thermoplastic resin is PVC.

16. The method of claim 11 comprising blending the thermoplastic resin with between 1.0 parts to 3.0 parts of the core-shell impact modifier per 100 parts of the thermoplastic resin.

17. The method of claim 11, wherein the core-shell impact modifier has a rubber content between 90 wt % and 96 wt %.

18. The thermoplastic composition of claim 1, wherein the core-shell impact modifier has a rubber content that is greater than 92 wt %.

19. The thermoplastic composition of claim 1, wherein the core-shell impact modifier has a rubber content between 93 wt % and 97 wt %.
